(19) United States
(12) Patent Application Publication
(10) Pub. No.: US 2021/0321006 A1
(43) Pub. Date: Oct. 14, 2021

(54) INSPECTION DEVICE, PROGRAM, AND INSPECTION SYSTEM

(71) Applicant: KONICA MINOLTA, INC., Tokyo (JP)

(72) Inventor: Takao KUROHATA, Tokyo (JP)

(73) Assignee: KONICA MINOLTA, INC., Tokyo (JP)

(21) Appl. No.: 17/186,437

(22) Filed: Feb. 26, 2021

(30) Foreign Application Priority Data
Apr. 14, 2020 (JP) 2020-072281

(51) Int. Cl. H04N 1/00; G06T 7/00; H04N 1/32

(52) U.S. Cl. CPC H04N 1/00005; G06T 7/0004; H04N 1/00411; G06T 2207/30124; H04N 1/00034; H04N 1/32662; G06T 2207/30168; H04N 1/0009

(57) ABSTRACT

An inspection device includes: a memory; and a controller that executes an inspection of an image of a sheet of paper by comparing the image of the sheet of paper output by a printing device for each of two or more jobs with a correct image of each image, wherein the controller stores, in the memory, an image judged to be an image defect in the inspection, and displays, on a display device, a list of images judged to be an image defect in the inspection of the two or more jobs.

The entire disclosure of Japanese patent Application No. 2020-072281, filed on Apr. 14, 2020, is incorporated herein by reference in its entirety.

### BACKGROUND

### Technological Field

The present disclosure relates to inspection of image defects on a sheet of paper output from a printing device.

### Description of the Related Art

There have been proposed various techniques for inspecting image defects on a sheet of paper by comparing an image on the sheet of paper output from a printing device such as a conventional multi-functional peripheral (MFP) with an image to be output.

For example, JP 2005-205682 A discloses an abnormality detecting apparatus that detects the number of occurrences of each type of image defects (dirt, omission, and so on) detected on a printed sheet of paper. JP 6-210835 A discloses an inspection device that determines the quality of a printed matter and displays an image of the printed matter determined to be defective together with an image of the printed matter determined to be good. JP 6-210836 A discloses an inspection device that determines the quality of a printed matter and displays image data of the printed matter determined to be defective together with print information (item name, allowable value, defect occurrence position, and so on).

While the conventional techniques described above can provide the user with information regarding a temporary image defect that occurs on a printed matter of a printing device, it is desired to provide more useful information.

### SUMMARY

The present disclosure has been conceived in view of such circumstances, and its object is to provide a technique for providing a user with useful information regarding an image defect occurring on a printed matter of a printing device.

To achieve the abovementioned object, according to an aspect of the present invention, an inspection device reflecting one aspect of the present invention comprises: a memory; and a controller that executes an inspection of an image of a sheet of paper by comparing the image of the sheet of paper output by a printing device for each of two or more jobs with a correct image of each image, wherein the controller stores, in the memory, an image judged to be an image defect in the inspection, and displays, on a display device, a list of images judged to be an image defect in the inspection of the two or more jobs.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a view showing an example of a schematic configuration of a printing device, which is an example of an inspection device;

FIG. 2 is a view showing an example of a detailed hardware configuration of the printing device, which is an example of an inspection device;

FIG. 3 is a flowchart of information management processing executed in the printing device in connection with inspection of an image defect;

FIG. 4 shows an example of a data structure of abnormal image information;

FIG. 5 is a view for explaining an example of four regions defined on a sheet of paper;

FIG. 6 is a view schematically showing an example of sheets of paper output for six jobs in which images are formed in the printing device;

FIG. 7 is a flowchart of processing executed by the printing device for displaying information regarding a detected image defect;

FIG. 8 is an example of a menu screen displayed in step S20;

FIG. 9 is a view showing an example of a screen that displays a list of images of pages on which an image defect has occurred;

FIG. 10 is a view showing another example of a screen that displays a list of images of pages on which an image defect has occurred;

FIG. 11 is a view showing an example of a menu screen related to classification display;

FIG. 12 is a view for explaining display according to the type of image defect;

FIG. 13 is a view for explaining display according to the type of image defect;

FIG. 14 is a view for explaining display according to the type of image defect;

FIG. 15 is a view for explaining display according to the type of image defect;

FIG. 16 is a view for explaining display according to the level of image defect;

FIG. 17 is a view for explaining display according to the level of image defect;

FIG. 18 is a view for explaining display according to the level of image defect;

FIG. 19 is a view for explaining display according to the position of image defect;

FIG. 20 is a view for explaining display according to the position of image defect;

FIG. 21 is a view for explaining display according to the position of image defect;

FIG. 22 is a view for explaining display according to the position of image defect;

FIG. 23 is a view for explaining display according to the position of image defect;

FIG. 24 is a view for explaining display of statistical information of image defect;

FIG. 25 is a view showing an example of a screen that displays statistical information;

FIG. 26 is a view showing an example of a configuration of an inspection system including two or more printing devices; and

FIG. 27 is a view showing an example of a hardware configuration of a management device.

### DETAILED DESCRIPTION OF EMBODIMENTS

Hereinafter, one or more embodiments of an inspection device and an inspection system according to the present invention will be described with reference to the drawings. However, the scope of the invention is not limited to the disclosed embodiments. In the following description, identical parts and components are given identical reference numerals. Their names and functions are the same. Therefore, these descriptions will not be repeated.

[Schematic Configuration of Inspection Device]

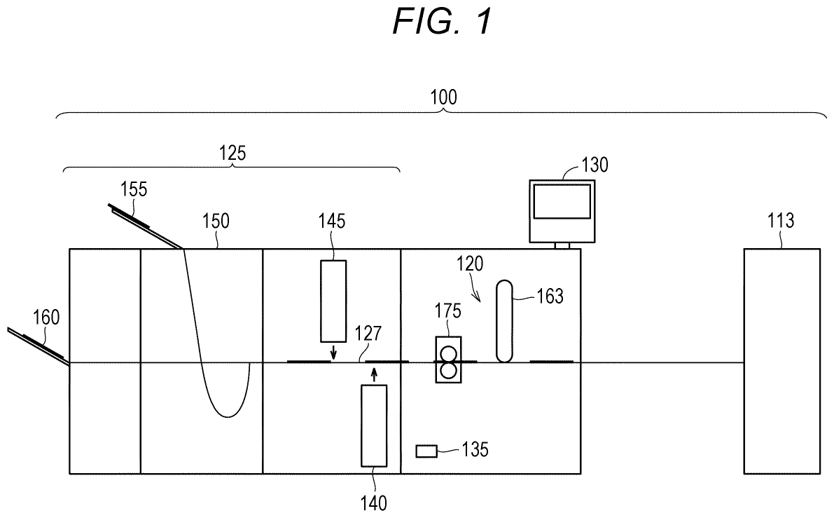

FIG. 1 is a view showing an example of a schematic configuration of the printing device 100, which is an example of an inspection device.

The printing device 100 includes a printer controller 113, an image formation unit 120, a post-processing device 125, a conveyance device 127, an operation panel 130, and a control device 135.

The printer controller 113 performs raster image processor (RIP) processing on the basis of manuscript data included in a print job received by the printing device 100 from a client terminal via a communication line, and generates RIP image data that is bit map data. The manuscript data can include graphic, character, and background data.

The image formation unit 120 prints a print image on a sheet of paper on the basis of the RIP image data generated by the printer controller 113. Details of the image formation unit 120 will be described later.

The post-processing device 125 reads the print image formed on the sheet of paper and switches the conveyance direction of the sheet of paper according to whether or not an image defect has occurred. The post-processing device 125 and the image defect will be described later.

The conveyance device 127 feeds, toward the image formation unit 120 on a one by one basis, sheets of paper of the type (e.g., size, grammage, and paper type) designated by the print job. Furthermore, the conveyance device 127 conveys, to the post-processing device 125, the paper on which the image is formed in the image formation unit 120.

The operation panel 130 receives an operation input to the printing device 100 from the user. Furthermore, the operation panel 130 displays a screen such as a setting screen on the basis of a command from the control device 135.

The control device 135 controls the operation of the printing device 100. The control device 135 makes various judgments in the operation of the printing device 100.

The image formation unit 120 includes an intermediate transfer belt 163 and a fixing unit 175. The intermediate transfer belt 163 supports a toner image transferred from a photoreceptor (not illustrated) and conveys the supported toner image to a transfer device (not illustrated). The transfer device transfers, to a sheet of paper, the toner image formed on the intermediate transfer belt 163. The fixing unit 175 pressurizes and heats the print image formed on the sheet of paper. Thus, the print image is fixed on the sheet of paper.

In the example of FIG. 1, the image formation unit 120 forms a print image or the like on a sheet of paper by an electrophotographic method. In another aspect, the image formation unit 120 may form a print image or the like on a sheet of paper by an ink jet method. The method of forming the print image is not limited.

More specifically, the post-processing device 125 includes reading devices 140 and 145, a purge unit 150, a purge tray 155, and a discharge tray 160.

The reading devices 140 and 145 read a print image formed on a sheet of paper and generate read image data corresponding to the surface of the sheet of paper having been read. For example, when the reading device 140 reads the print image on the front surface of the sheet of paper, the reading device 145 reads the print image on the back surface of the sheet of paper. In a single-sided printing j ob, when the image formation unit 120 forms a print image on only one side of a sheet of paper, only one of the reading devices 140 and 145 read the surface of the sheet of paper on which the print image is formed. In a certain aspect, the reading devices 140 and 145 are implemented by a charge coupled device (CCD) sensor.

In accordance with whether or not an image defect has occurred in a print image formed on a sheet of paper, the purge unit 150 switches the direction in which the sheet of paper is conveyed by the conveyance device 127. For example, the purge unit 150 switches the conveyance direction of the sheet of paper so that the sheet of paper having the image defect is conveyed by the conveyance device 127 to the purge tray 155. At this time, the purge unit 150 switches the conveyance direction of the sheet of paper so that the sheet of paper having no image defect is conveyed by the conveyance device 127 to the discharge tray 160.

[Hardware Configuration of Inspection Device]

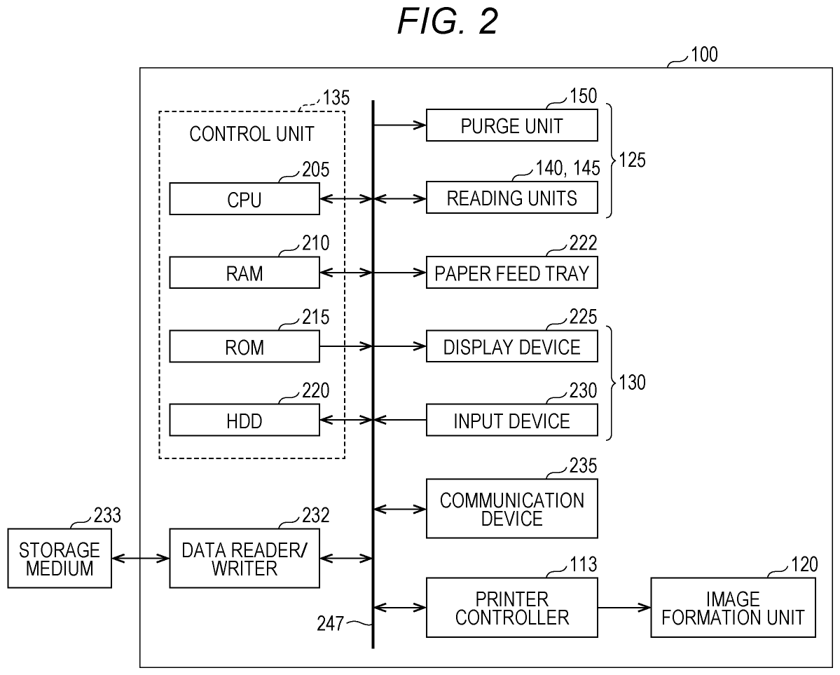

FIG. 2 is a view showing an example of a detailed hardware configuration of the printing device 100, which is an example of the inspection device.

The printing device 100 includes the operation panel 130, the control device 135, a paper feed tray 222, a data reader/writer 232, a communication device 235, and a bus 247.

The paper feed tray 222 accommodates sheets of paper. The printing device 100 can include a plurality of the paper feed trays 222. The sheet of paper of the type designated by the print job is taken out on the one by one basis by the conveyance device 127 from the paper feed tray 222 accommodating the sheet of paper of the designated type of the plurality of paper feed trays 222.

The operation panel 130 includes a display device 225 and an input device 230. The operation panel 130 includes a touch screen in which the display device 225 such as a liquid crystal monitor and the input device 230 such as a plurality of touch sensors are combined. The operation panel 130 may further include a plurality of physical keys as the input device 230.

When an external storage medium 233 such as an external hard disk drive (HDD) is detachably mounted, the data reader/writer 232 writes data or a program including an image into the mounted storage medium 233 or reads data from the storage medium 233 on the basis of a command from the CPU 205. The storage medium 233 stores information of a recorded program or the like by electric, magnetic, optical, mechanical, or chemical action so that the computer or other device can read the information of the program or the like.

The communication device 235 is connected with external equipment such as a client terminal via a communication line. In a certain aspect, the communication device 235 is implemented by a wired local area network (LAN) port, a wireless fidelity (Wi-Fi) (registered trademark) module, and the like. The printing device 100 receives a job from the external equipment such as a client terminal via the communication device 235. The printing device 100 may include a plurality of the communication devices 235. Components of the printing device 100 communicate with each other via the bus 247.

The control device 135 includes a central processing unit (CPU) 205, a random access memory (RAM) 210, a read only memory (ROM) 215, and an HDD 220.

The CPU 205 executes a control program for controlling the printing device 100. As an example, the CPU 205 executes a program for judging whether or not an image defect has occurred in display of a setting screen, print processing, and a print image.

The RAM 210 stores an application program executed by the CPU 205 and reference data. In a certain aspect, the RAM 210 can be implemented in a static random access memory (SRAM) or a dynamic random access memory (DRAM).

The ROM 215 stores a program such as an operating system (OS) executed by the CPU 205. In a certain aspect, the ROM 215 can be implemented by an erasable programmable ROM (EPROM), an electrically erasable programmable ROM (EEPROM), or a flash memory.

The HDD 220 stores various programs and data used in the printing device 100. In another aspect, the HDD 220 may be replaced with an auxiliary storage device such as a solid state drive (SSD).

[Inspection in Inspection Device]

In the printing device 100, the control device 135 can inspect the print image and detect the occurrence of an image defect in the print image. In this sense, the printing device 100 including the control device 135 can function as an inspection device.

In one embodiment, the control device 135 can detect the occurrence of an image defect by comparing the image on the sheet of paper read by the reading device 140 and/or the reading device 145 with a reference image. The reference image is an example of a correct image, for example, an image corresponding to RIP image data generated from manuscript data included in a print job. The type of image defects to be detected includes “dirt”, “void hickey”, and “streak” detected by an image forming apparatus described in JP 2020-046523 A, for example.

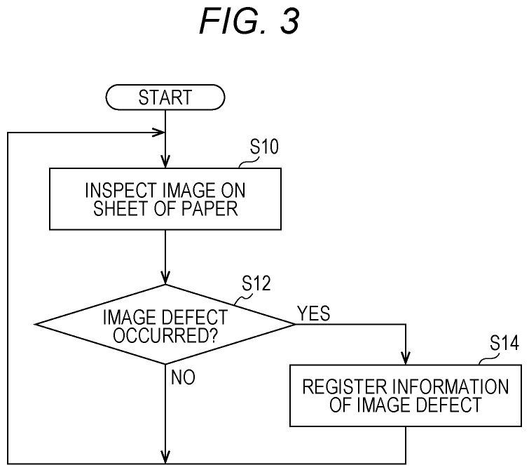

FIG. 3 is a flowchart of information management processing executed in the printing device 100 in connection with inspection of an image defect. The processing of FIG. 3 starts, for example, together with the start of a print job in the printing device 100. In one embodiment, the printing device 100 may execute information management processing by causing the CPU 205 to execute a given program. In one embodiment, the printing device 100 may include a dedicated circuit such as an application specific integrated circuit (ASIC) or a field-programmable gate array (FPGA), and may execute information management processing as a function of the dedicated circuit.

In step S10, the printing device 100 inspects the image on a sheet of paper by comparing it with a reference image, for example.

In step S12, the printing device 100 judges whether or not the occurrence of an image defect in the image on the sheet of paper has been detected in the inspection of step S10. The printing device 100 proceeds with the control to step S14 if judging that an image defect has been detected (YES in step S12), and returns the control to step S10 if not (NO in step S12) and performs an inspection on the image on the next sheet paper.

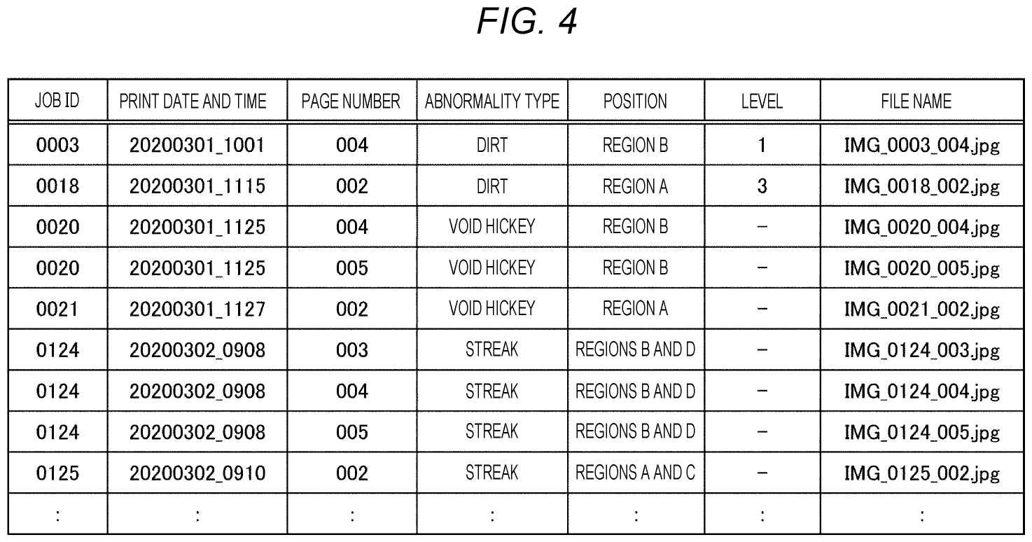

In step S14, the printing device 100 registers, into abnormal image information, information on the detected image defect. Thereafter, the printing device 100 returns the control to step S10 to perform an inspection on the image on the next sheet of paper. The abnormal image information is an accumulation of pieces of information on image defects detected by the printing device 100, and its contents will be described later with reference to FIG. 4.

[Abnormal Image Information]

FIG. 4 shows an example of the data structure of abnormal image information. The abnormal image information is stored, for example, in the HDD 220. As shown in FIG. 4, the abnormal image information includes “job ID”, “print date and time”, “page number”, “abnormality type”, “position”, “level”, and “file name”.

The “job ID” defines a job to which the image in which an image defect is detected belongs. For example, a job ID “0003” indicates that an image defect has been detected in the image printed for the job specified as “0003”.

The “print date and time” defines the execution start date and time of the job in which the image defect has been detected. For example, the print date and time “20200301_1001” indicates that the job in which the image defect has been detected was started at 10:01 on Mar. 1, 2020.

The “page number” defines which page of the image data of the job the image formed on the sheet of paper on which the image defect has been detected is on. For example, the page number “004” indicates that the sheet of paper on which the image defect has been detected is the sheet of paper on which the image of the fourth page of the job is formed.

The “abnormality type” defines the type of detected image defect. In one embodiment, the type of image defect is “dirt”, “void hickey”, or “streak”, but the type of image defect to be registered is not limited thereto.

The “position” defines the position of the detected image defect on the sheet of paper. In one embodiment, any of regions A to D defined for the sheet of paper is registered as the value of the position on the sheet of paper.

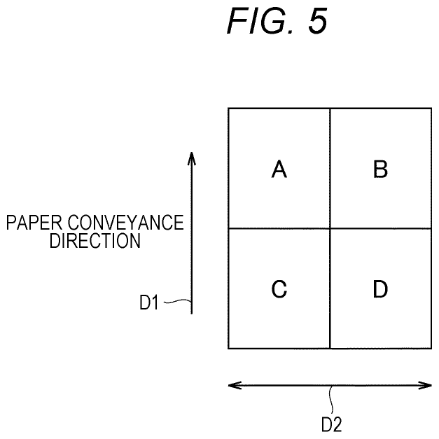

FIG. 5 is a view for explaining an example of the four regions defined on a sheet of paper. In FIG. 5, an arrow D1 indicating the conveyance direction of the sheet of paper and an arrow D2 indicating the direction intersecting the conveyance direction (width direction of the sheet of paper) are shown with respect to a region X representing the sheet of paper. In the example of FIG. 5, the region A is set on one side and the region B is set on the other side on the downstream side in the conveyance direction of the sheet of paper. On the upstream side in the conveyance direction of the sheet of paper, the region C is set on one side and the region D is set on the other side.

Returning to FIG. 4, when detecting the occurrence of an image defect, the printing device 100 specifies the occurrence location of the image defect, specifies the region (regions A to D) to which the occurrence location belongs, and registers the specified region as the “position” into the abnormal image information.

The “level” defines the level of detected image defect. In one embodiment, the HDD 220 of the printing device 100 stores information (e.g., area of the image defect) for specifying the level of each type of image defect (e.g., dirt, streak, void hickey, and so on). In the printing device 100, when an image defect is detected, the level of the image defect is specified and registered in the abnormal image information.

The “file name” defines the file name of the image of the sheet of paper on which the image defect has been detected. The printing device 100 generates an image file of the sheet of paper by the reading device 140 and/or the reading device 145 reading the image of the sheet of paper on which the image is formed. In the printing device 100, when an image defect is detected, the image file of the sheet of paper on which the image defect has been detected is stored in the HDD 220. The “file name” of the abnormal image information represents the file name of the image file stored in this manner.

[Specific Example of Abnormal Image Information]

FIG. 6 is a view schematically showing an example of sheets of paper output for six jobs in which images are formed in the printing device 100. In the example of FIG. 6, each of frames 301, 302, 303, 304, 305, and 306 represents one or more sheets of paper output for one job. In the example of FIG. 6, six sheets of paper are shown in each of the frames 301, 302, 303, 304, 305, and 306, and, a number indicating the page of each sheet of paper is shown for explanation. The number of page included in each job in FIG. 6 is merely an example.

The example of FIG. 6 corresponds to the abnormal image information of FIG. 4. Hereinafter, how the abnormal image information of FIG. 5 corresponds to the example of FIG. 6 will be described.

In the example of FIG. 6, an image defect of “dirt” occurs on the sheet of paper of the fourth page in the job shown in the frame 301, but no image defect occurs on the sheets of paper of the other pages.

The dirt generated on the fourth page of the job in the frame 301 is registered in the first line of the abnormal image information in FIG. 4. That is, the dirt on the fourth page of the job of the frame 301 is positioned in the region B, and the level specified for the dirt is “1”. The image of this page is registered with a file name “IMG_0003_004jpg”. In this example, the name of the image file includes a character string representing the job ID (0003) and the page number (004). However, the format of the name of the image file is not limited thereto.

In the example of FIG. 6, an image defect of “dirt” occurs on the sheet of paper of the second page in the job shown in the frame 302, but no image defect occurs on the sheets of paper of the other pages.

The dirt generated on the second page of the job in the frame 302 is registered in the second line of the abnormal image information in FIG. 4. That is, the dirt on the second page of the job of the frame 302 is positioned in the region A, and the level specified for the dirt is “3”. The image of this page is registered with a file name “IMG_0018_002jpg”.

In the example of FIG. 6, an image defect of “void hickey” occurs on the sheet of paper of each of the fourth page and the fifth page in the job shown in the frame 303, but no image defect occurs on the sheets of paper of the other pages.

The void hickey generated on the fourth page of the job in the frame 303 is registered in the third line of the abnormal image information in FIG. 4. That is, the void hickey on the fourth page of the job of the frame 303 is positioned in the region B. No level has been specified for the void hickey. The image of this page is registered with a file name “IMG_0020_004jpg”.

The void hickey generated on the fifth page of the job in the frame 303 is registered in the fourth line of the abnormal image information in FIG. 4. That is, the void hickey on the fifth page of the job of the frame 303 is positioned in the region B. No level has been specified for the void hickey. The image of this page is registered with a file name “IMG_0020_005jpg”.

In the example of FIG. 6, an image defect of “void hickey” occurs on the sheet of paper of the second page in the job shown in the frame 304, but no image defect occurs on the sheets of paper of the other pages.

The void hickey generated on the second page of the job in the frame 304 is registered in the fifth line of the abnormal image information in FIG. 4. That is, the void hickey on the second page of the job of the frame 304 is positioned in the region A. No level has been specified for the void hickey. The image of this page is registered with a file name “IMG_0021_002jpg”.

In the example of FIG. 6, an image defect of “streak” occurs on the sheet of paper of each of the third page to the fifth page in the job shown in the frame 305, but no image defect occurs on the sheets of paper of the other pages.

The streak generated on each of the third page to the fifth page of the job in the frame 305 is registered on each of the fifth lines to the seventh line of the abnormal image information in FIG. 4. That is, the streak on each of the third page to the fifth page of the job of the frame 305 is positioned in the region B and the region D. No level has been specified for the streak. The images on these pages are registered with file names “IMG_0124_003jpg”, “IMG_0124_004jpg”, and “IMG_0124_005jpg”.

In the example of FIG. 6, an image defect of “streak” occurs on the sheet of paper of the second page in the job shown in the frame 306, but no image defect occurs on the sheets of paper of the other pages.

The streak generated on the second page of the job in the frame 306 is registered in the eighth line of the abnormal image information in FIG. 4. That is, the streak on the second page of the job of the frame 306 is positioned in the region A and the region C. No level has been specified for the streak. The image of this page is registered with a file name “IMG_0125_002jpg”.

[Display of Information Regarding Detected Image Defect]

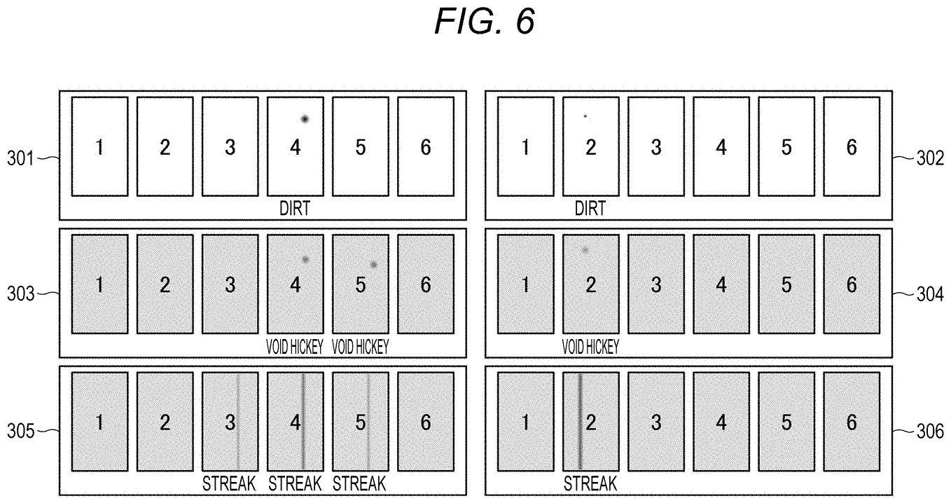

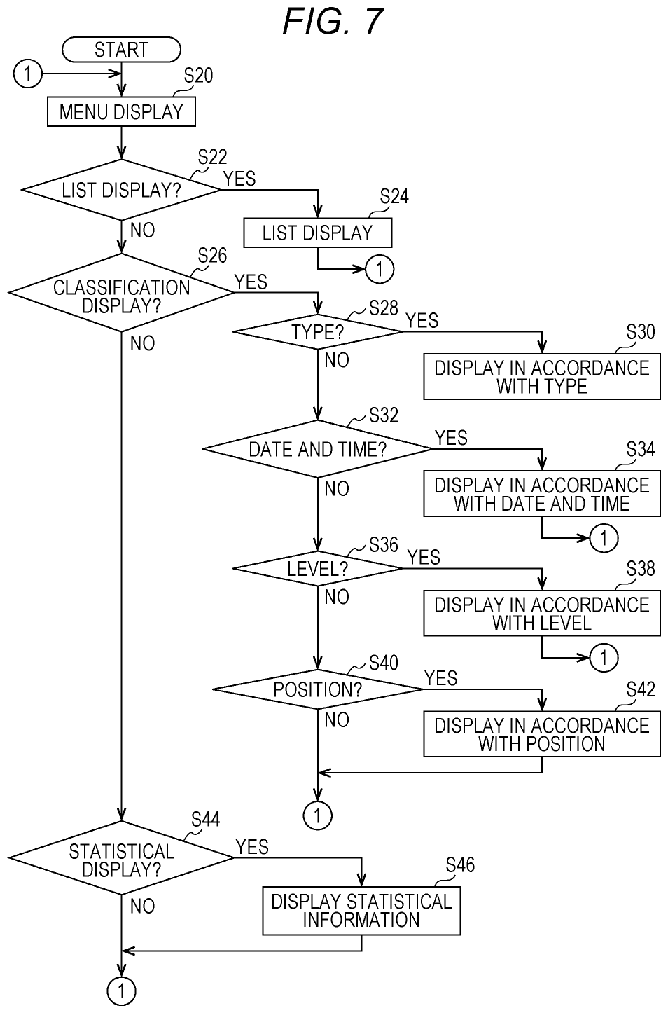

FIG. 7 is a flowchart of processing executed by the printing device 100 for displaying information regarding a detected image defect. The processing of FIG. 7 is started in response to, for example, an operation of requesting the input device 230 to display information. In one embodiment, the printing device 100 may execute the processing of FIG. 7 by causing the CPU 205 to execute a given program. In one embodiment, the printing device 100 may include a dedicated circuit such as an ASIC or a FPGA, and may execute the processing of FIG. 7 as a function of the dedicated circuit.

With reference to FIG. 7, in step S20, the printing device 100 displays a menu on the display device 225.

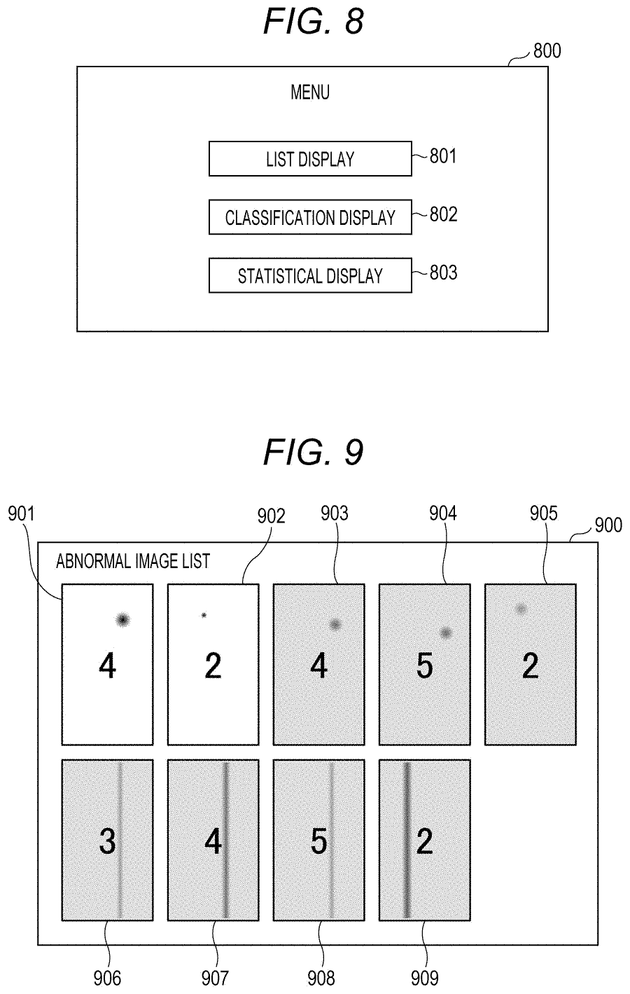

FIG. 8 is an example of a menu screen displayed in step S20. A menu screen 800 of FIG. 8 includes keys 801, 802, and 803. The key 801 is operated to instruct the list display of information. The key 802 is operated to instruct the display of classified information. The key 803 is operated to instruct the display of statistical information. The user operates a key in accordance with a desired display mode on the menu screen 800.

Returning to FIG. 7, in step S22, the printing device 100 judges whether or not “list display” has been selected in the menu (menu screen 800) displayed in step S20. The printing device 100 proceeds with the control to step S24 if judging that the list display has been selected (YES in step S22), and proceeds with the control to step S26 if not (NO in step S22).

In step S24, the printing device 100 displays, on the display device 225, a list of images of pages on which an image defect has occurred. Thereafter, upon receiving an instruction to end the list display, the printing device 100 returns the control to step S20.

FIG. 9 is a view showing an example of a screen that displays a list of images of pages on which an image defect has occurred. In a list display screen 900 of FIG. 9, nine page images 901 to 909 are displayed. The page images 901 to 909 are images of respective nine file names registered in the abnormal image information (FIG. 4). That is, the printing device 100 reads the respective image data of the file names registered in the abnormal image information and displays them on the list display screen 900. In a case where the number of file names registered in the abnormal image information is too large to fit the entire list display screen in the display device 225, the user can visually recognize the entire list display screen by scrolling the list display screen.

Information on image defects of a plurality of jobs is registered in the abnormal image information. Therefore, the list display screen 900 displays a list of images of pages having been judged to be abnormal (image defect) in the inspection for two or more jobs.

That is, in the present embodiment, when an image defect has occur in sheet of papers output from the printing device 100 for two or more jobs, images of the sheets of paper including image defects output in the two or more jobs are displayed in a list. The list display screen 900 includes the page images 901 to 909. The page image 901 includes an image defect occurred in the first job. The page image 902 includes an image defect occurred in the second job. The page images 903 and 904 include image defects occurred in the third job. The page image 905 includes an image defect occurred in the fourth job. The page images 906 to 908 include image defects occurred in the fifth job. The page image 909 includes an image defect occurred in the sixth job.

The printing device 100 can adjust the size of the image of each page when performing the list display as shown in FIG. 9. In one embodiment, the printing device 100 performs an adjustment such that the image of each page is displayed in the same size. Thus, even if an image defect occurs in a sheet of paper of A4, or even if an image defect occurs in a sheet of paper of A3, the image of each sheet of paper is displayed in the same size on the list display screen. This can facilitate comparison of image defects between sheets of paper.

On the other hand, the printing device 100 may display the image of each page in a size corresponding to the size of the sheet of paper of each page in the list display as shown in FIG. 9. This can more accurately reproduce the state in which the image defect occurs.

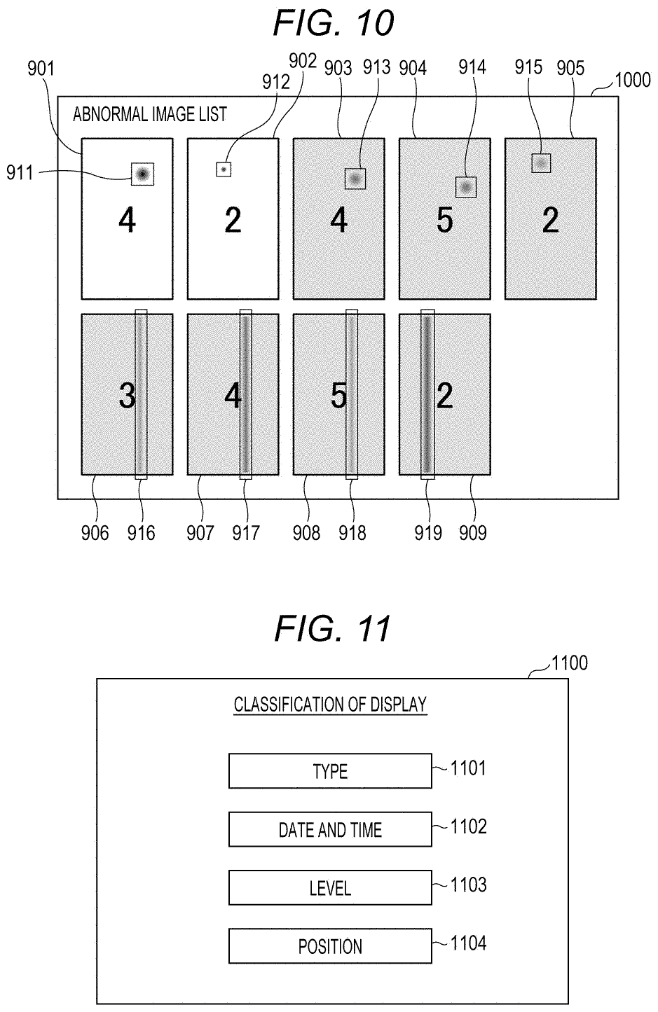

FIG. 10 is a view showing another example of a screen that displays a list of images of pages on which an image defect has occurred. In a list display screen 1000 in FIG. 10, the page images 901 to 909 are provided with frames 911 to 919, respectively. In the page images 901 to 909, each of the frames 911 to 919 indicates a location where an image defect (dirt, void hickey, streak, and so on) has occurred. The printing device 100 may register, into the abnormal image information, information specifying a portion where an image defect occurs in the inspection of each page, and may generate the frames 911 to 919 as frames covering the portion and add them to the list display screen.

Returning to FIG. 8, in step S26, the printing device 100 judges whether or not “classification display” has been selected in the menu (menu screen 800) displayed in step S20. The printing device 100 proceeds with the control to step S28 if judging that the classification display has been selected (YES in step S26), and proceeds with the control to step S44 if not (NO in step S26).

FIG. 11 is a view showing an example of a menu screen related to classification display. The printing device 100 may further provide a menu for classification display when the classification display is selected in step S26. A menu screen 1100 of FIG. 11 includes four keys 1101, 1102, 1103, and 1104. The key 1101 is operated to instruct classification in accordance with the type of image defect. The key 1102 is operated to instruct classification in accordance with the occurrence date and time of image defect. The key 1103 is operated to instruct classification in accordance with the level of image defect. The key 1104 is operated to instruct classification in accordance with the occurrence position of image defect.

In step S28, the printing device 100 judges whether or not an instruction of classification in accordance with the type of image defect has been received for the classification display. The printing device 100 proceeds with the control to step S30 if an instruction of classification in accordance with the type of image defect has been received (YES in step S28), and proceeds with the control to step S32 if not (NO in step S28).

In step S30, the printing device 100 executes control for displaying the image of the file name registered in the abnormal image information in accordance with the type of image defect. Thereafter, upon receiving an instruction to end the display in accordance with the type of image defect, the printing device 100 returns the control to step S20.

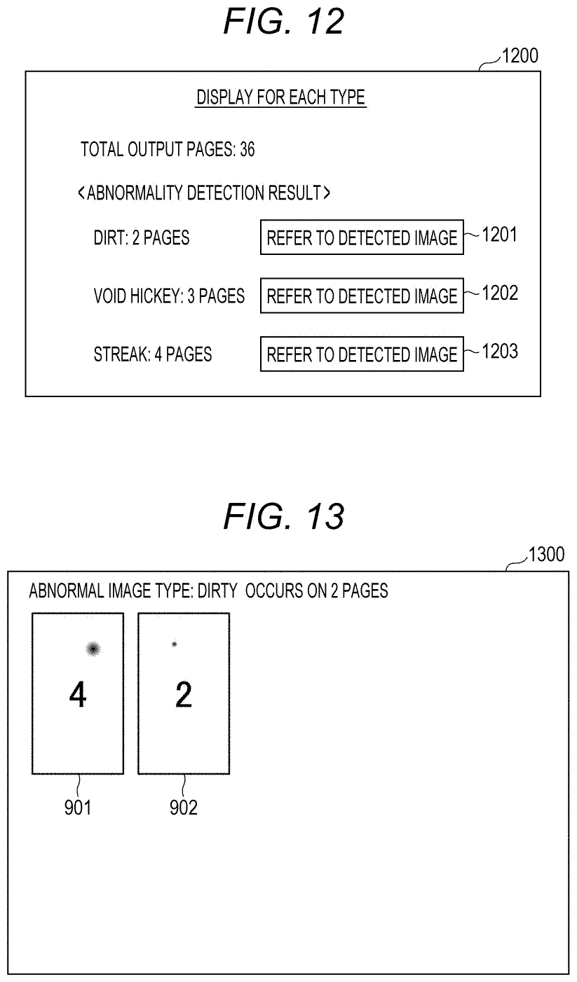

FIGS. 12 to 15 are views for explaining display according to the type of image defect. FIG. 12 shows a screen 1200 for selecting the type of image defect to be displayed. The screen 1200 includes three keys 1201, 1202, and 1203. The keys 1201, 1202, and 1203 are operated to select the types “dirt”, “void hickey”, and “streak”, respectively. As “Dirt: Page 2” and the like in FIG. 12, the printing device 100 may display on the screen 1200 the number of pages including each type of image defect.

FIG. 13 shows a screen 1300 for displaying an image of a page including an image defect of the type “dirt”. By an operation made to the key 1201 of the screen 1200, the screen 1300 is displayed, and includes the page images 901 and 902 of the page images 901 to 909 displayed on the list display screen 900.

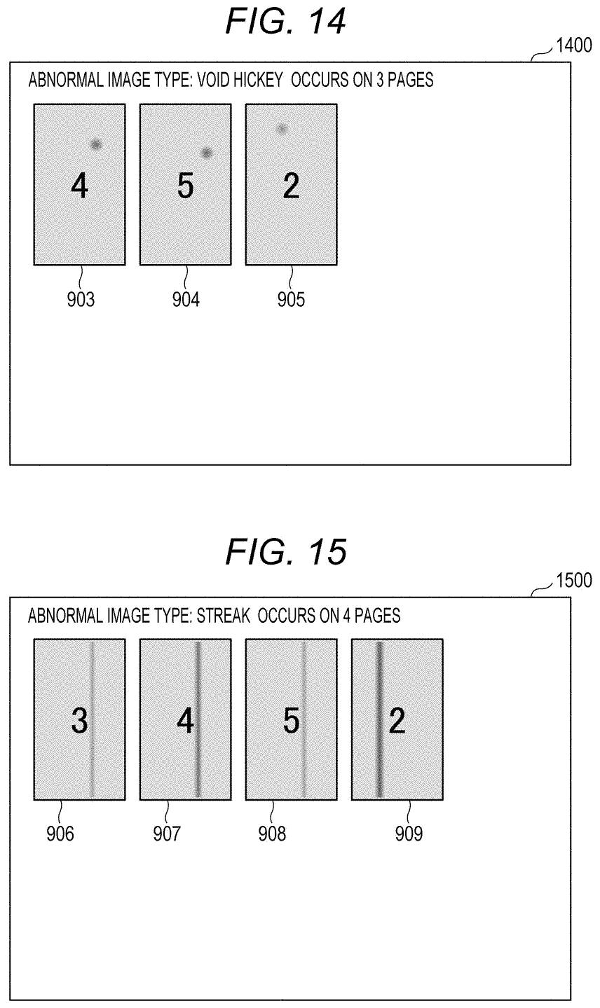

FIG. 14 shows a screen 1400 for displaying an image of a page including an image defect of the type “void hickey”. By an operation made to the key 1202 of the screen 1200, the screen 1400 is displayed, and includes the page images 903, 904, and 905 of the page images 901 to 909 displayed on the list display screen 900.

FIG. 15 shows a screen 1500 for displaying an image of a page including an image defect of the type “streak”. By an operation made to the key 1203 of the screen 1200, the screen 1500 is displayed, and includes the page images 906 to 909 of the page images 901 to 909 displayed on the list display screen 900.

Returning to FIG. 7, in step S32, the printing device 100 judges whether or not an instruction of classification in accordance with the occurrence date and time of image defect has been received for the classification display. The printing device 100 proceeds with the control to step S34 if an instruction of classification in accordance with the occurrence date and time of image defect has been received (YES in step S32), and proceeds with the control to step S36 if not (NO in step S32).

In step S34, the printing device 100 executes control for displaying the image of the file name registered in the abnormal image information in accordance with the occurrence date and time of image defect. Thereafter, upon receiving an instruction to end the display in accordance with the occurrence date and time of image defect, the printing device 100 returns the control to step S20.

In one embodiment, in step S34, the printing device 100 accepts designation of a period, extracts, from the abnormal image information, information in which the print date and time is included in the designated period, and displays, on the display device 225, the image of the file name of the extracted information. A date may be designated as the period.

In the abnormal image information of FIG. 4, the print date and time of the information of the first five lines include Mar. 1, 2020. For example, if “Mar. 1, 2020” is designated as the period (date), the printing device 100 displays, on the display device 225, the images of the file names of the first five lines of the abnormal image information.

Returning to FIG. 7, in step S36, the printing device 100 judges whether or not an instruction of classification in accordance with the level of image defect has been received for the classification display. The printing device 100 proceeds with the control to step S38 if an instruction of classification in accordance with the level of image defect has been received (YES in step S36), and proceeds with the control to step S40 if not (NO in step S36).

In step S38, the printing device 100 executes control for displaying the image of the file name registered in the abnormal image information in accordance with the level of image defect. Thereafter, upon receiving an instruction to end the display in accordance with the level of image defect, the printing device 100 returns the control to step S20.

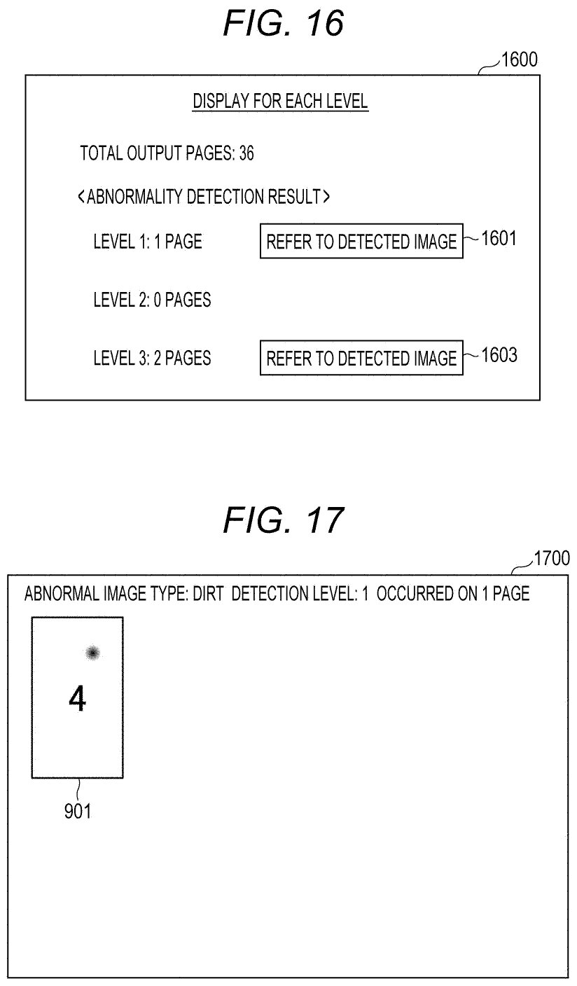

FIGS. 16 to 18 are views for explaining display according to the level of image defect. FIG. 16 shows a screen 1600 for selecting the level of image defect to be displayed. The screen 1600 includes two keys 1601 and 1603. Each of the keys 1601 and 1603 is operated to select the level of image defect.

In the present embodiment, “level 1” indicates that the degree of image defect is higher than that of “level 2”, and “level 2” indicates that the degree of image defect is higher than that of “level 3”. That is, the image defect of “level 1” corresponds to the image defect of “level 2”, and the image defects of “level 1” and “level 2” correspond to the image defect of “level 3”. Such setting mode of the level of image defect is merely an example. The setting mode of the level of image defect can be set as appropriate in systems to which the technique according to the present disclosure is applied.

As “Level 1: Page 1”, “Level 3: Page 2”, and the like in FIG. 16, the printing device 100 may display on the screen 1600 the number of pages including each level of image defect.

FIG. 17 shows a screen 1700 for displaying an image of a page including an image defect of “level 1”. By an operation made to the key 1601 of the screen 1600, the screen 1700 is displayed, and includes the page image 901 of the page images 901 to 909 displayed on the list display screen 900.

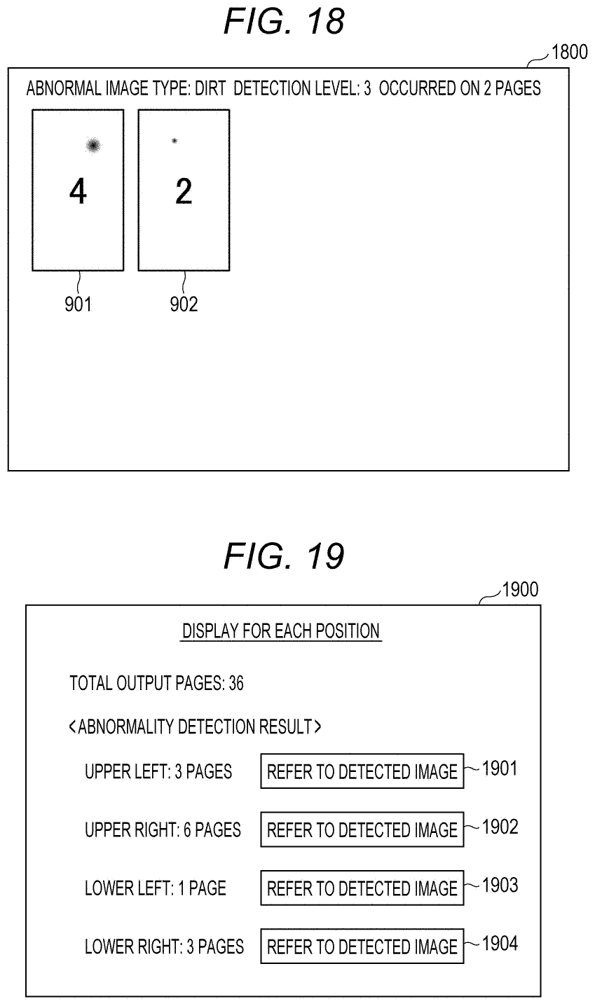

FIG. 18 shows a screen 1800 for displaying an image of a page including an image defect of “level 3”. By an operation made to the key 1603 of the screen 1600, the screen 1800 is displayed, and includes the page images 901 and 902 of the page images 901 to 909 displayed on the list display screen 900. The page image 901 includes an image defect of “level 1”. Since in the present embodiment, the image defect of “level 1” includes the image defect of “level 3”, the page image 901 is displayed on both the screen 1700 and the screen 1800.

Returning to FIG. 7, in step S40, the printing device 100 judges whether or not an instruction of classification in accordance with the position of image defect has been received for the classification display. The printing device 100 proceeds with the control to step S42 if an instruction of classification in accordance with the position of image defect has been received (YES in step S40), and proceeds with the control to step S20 if not (NO in step S40).

In step S42, the printing device 100 executes control for displaying the image of the file name registered in the abnormal image information in accordance with the position of image defect. Thereafter, upon receiving an instruction to end the display in accordance with the position of image defect, the printing device 100 returns the control to step S20.

FIGS. 19 to 23 are views for explaining display according to the position of image defect. FIG. 19 shows a screen 1900 for selecting the position of image defect to be displayed. The screen 1900 includes four keys 1901 to 1904. The key 1901 is operated to select the upper left (region A of FIG. 5) of the page as the position to be displayed. The key 1902 is operated to select the upper right (region B of FIG. 5) of the page as the position to be displayed. The key 1903 is operated to select the lower left (region C of FIG. 5) of the page as the position to be displayed. The key 1904 is operated to select the lower right (region D of FIG. 5) of the page as the position to be displayed.

As “Upper Left: Page 3”, “Upper Right: Page 6”, and the like in FIG. 19, the printing device 100 may display on the screen 1900 the number of pages including an image defect at each position.

FIG. 17 shows a screen 1700 for displaying an image of a page including an image defect of “position 1”. By an operation made to the key 1601 of the screen 1600, the screen 1700 is displayed, and includes the page image 901 of the page images 901 to 909 displayed on the list display screen 900.

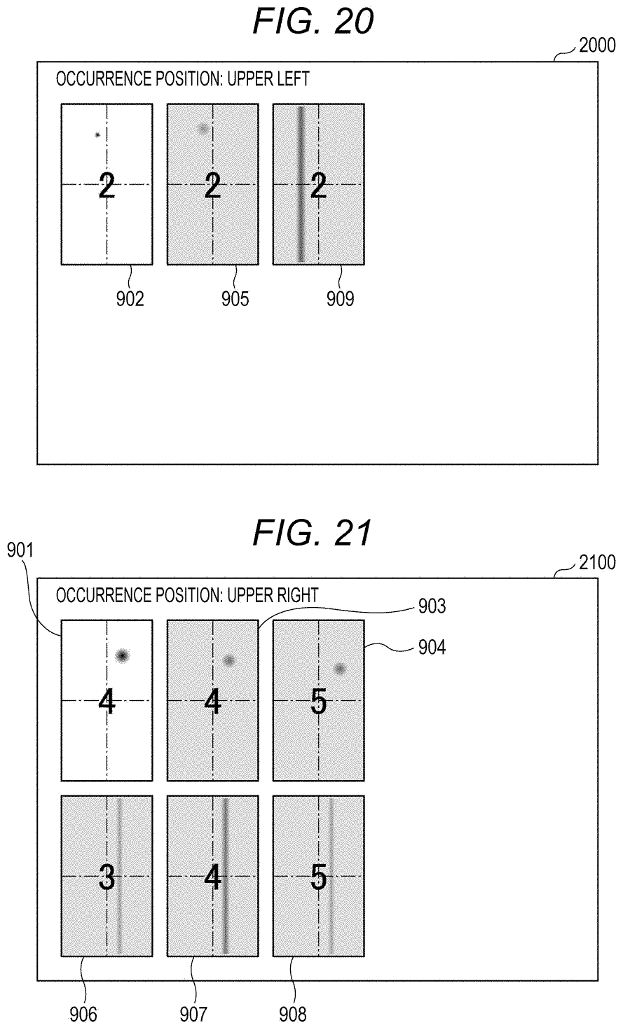

FIG. 20 shows a screen 2000 that displays an image of a page including an image defect on the upper left (region A of FIG. 5) of the page. By an operation made to the key 1901 of the screen 1900, the screen 2000 is displayed, and includes the page images 902, 905, and 909 of the page images 901 to 909 displayed on the list display screen 900.

FIG. 21 shows a screen 2100 that displays an image of a page including an image defect on the upper right (region B of FIG. 5) of the page. By an operation made to the key 1902 of the screen 1900, the screen 2100 is displayed, and includes the page images 901, 903, and 906 to 908 of the page images 901 to 909 displayed on the list display screen 900.

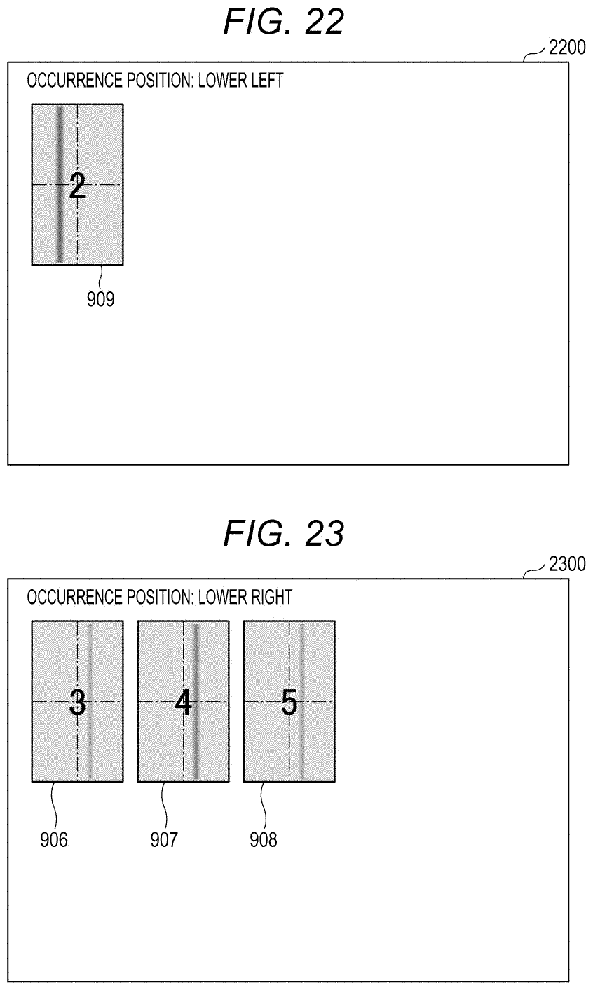

FIG. 22 shows a screen 2200 that displays an image of a page including an image defect on the lower left (region C of FIG. 5) of the page. By an operation made to the key 1903 of the screen 1900, the screen 2200 is displayed, and includes the page image 909 of the page images 901 to 909 displayed on the list display screen 900.

FIG. 23 shows a screen 2300 that displays an image of a page including an image defect on the lower right (region D of FIG. 5) of the page. By an operation made to the key 1904 of the screen 1900, the screen 2300 is displayed, and includes the page images 906 to 908 of the page images 901 to 909 displayed on the list display screen 900.

Returning to FIG. 7, in step S44, the printing device 100 judges whether or not an instruction of display of the statistical information of image defect has been received for the classification display. The printing device 100 proceeds with the control to step S46 if an instruction of display of the statistical information of image defect has been received (YES in step S44), and proceeds with the control to step S20 if not (NO in step S44).

In step S46, the printing device 100 executes control for displaying the information obtained by statistically processing the information registered in the abnormal image information. Thereafter, upon receiving an instruction to end the display of the statistical information, the printing device 100 returns the control to step S20.

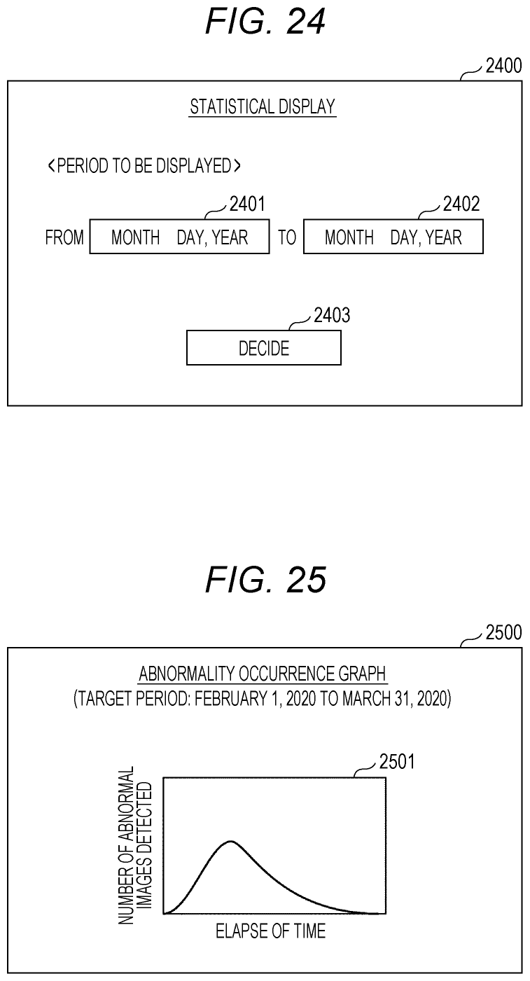

FIGS. 24 and 25 are views for explaining display of statistical information of image defect. FIG. 24 shows a screen 2400 for selecting a period to be displayed. On the screen 2400, a column 2401 accepts designation of the start time of the period, a column 2402 accepts designation of the end time of the period, and a column 2403 accepts instruction of display of statistical information for the designated period.

FIG. 25 is a view showing an example of a screen that displays statistical information. A screen 2500 of FIG. 25 includes a graph 2501. The printing device 100 generates statistical information of information registered in the abnormal image information for the period designated on the screen 2400, and generates image data of the graph 2501 using the generated information. In one embodiment, the statistical information is a time series of the number of occurrences of image defect per day. As statistical information, the printing device 100 may generate the number of occurrences of image defect for each type of image defect, for each level, for each occurrence position, or for a combination of type, level, and occurrence position (e.g., the number of occurrences of “dirt” in “region A” per day).

[Integration of Results of a Plurality of Printing Devices]

(Configuration of Inspection System)

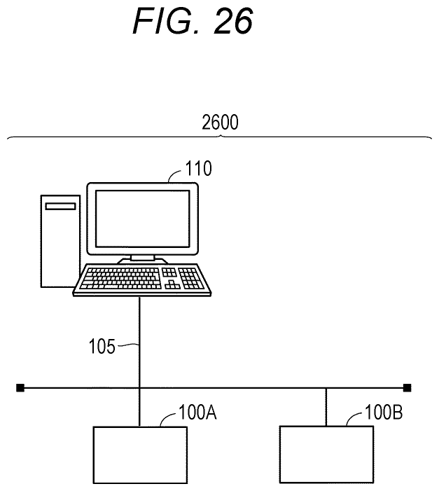

FIG. 26 is a view showing an example of the configuration of an inspection system including two or more printing devices. In FIG. 26, an inspection system 2600 includes the management device 110 and two printing devices 100A and 100B.

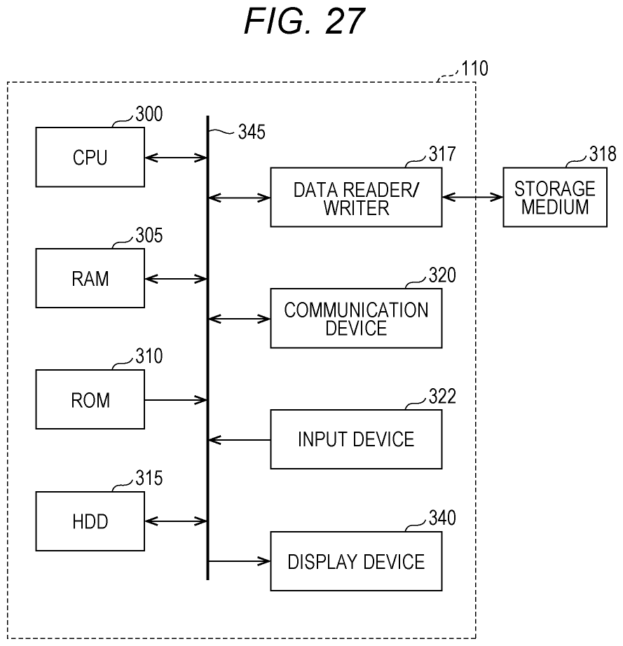

FIG. 27 is a view showing an example of the hardware configuration of the management device 110. As shown in FIG. 3, the management device 110 includes a CPU 300, a RAM 305, a ROM 310, an HDD 315, a data reader/writer 317, a communication device 320, an input device 322, a display device 340, and a bus 345.

The CPU 300 controls the operation of the entire management device 110. The communication device 320 is implemented by a wired LAN port, a Wi-Fi module, and the like. The configurations and functions of the RAM 305, the ROM 310, the HDD 315, the data reader/writer 317, a storage medium 318, the input device 322, the display device 340, and the bus 345 are the same as those of the RAM 210, the ROM 215, the HDD 220, the data reader/writer 232, the storage medium 233, the input device 230, the display device 225, and the bus 247, respectively. Therefore, these descriptions will not be repeated.

In the management device 110, the CPU 300 executes various processing by executing a given program. The management device 110 may include a dedicated circuit such as an ASIC or a FPGA in place of the CPU 300 or in addition to the CPU 300, and may execute various processing using the dedicated circuit.

Similarly to the printing device 100 of FIG. 1, each of the printing devices 100A and 100B forms an image on a sheet of paper, inspects the formed image, and generates abnormal image information. In the inspection system 2600, each of the printing devices 100A and 100B transmits, to the management device 110, the abnormal image information generated in each of them.

In one embodiment, the management device 110 generates an abnormal image information database by integrating the abnormal image information acquired from the printing devices 100A and 100B. Using the abnormal image information database, the management device 110 executes the display processing described with reference to FIG. 7. It is preferable that the management device 110 displays the information of the image defect as shown in FIG. 7 separately for each printing device in which the image defect occurs.

Although embodiments of the present invention have been described and illustrated in detail, the disclosed embodiments are made for purposes of illustration and example only and not limitation. The scope of the present invention should be interpreted by terms of the appended claims rather than by terms of the description described above, and is intended to include the meaning equivalent to the claims and all modifications made within the scope of the claims. It is intended that the invention described in the embodiments and the modifications is practiced, wherever possible, either alone or in combination.

What is claimed is:

1. An inspection device comprising:
a memory; and
a controller that executes an inspection of an image of a sheet of paper by comparing the image of the sheet of paper output by a printing device for each of two or more jobs with a correct image of each image, wherein
the controller
stores, in the memory, an image judged to be an image defect in the inspection, and
displays, on a display device, a list of images judged to be an image defect in the inspection of the two or more jobs.

2. The inspection device according to claim 1, wherein
the controller
specifies a type of image defect in the inspection, and
displays, for each type of the image defect, an image judged to be an image defect in the inspection.

3. The inspection device according to claim 1, wherein
the controller
stores, in the memory together with information on print date and time, an image judged to be an image defect in the inspection, and
displays, in accordance with print date and time, an image judged to be an image defect in the inspection.

4. The inspection device according to claim 1, wherein
the controller
specifies a level of image defect in the inspection, and
displays, in accordance with a level specified for each image, an image judged to be an image defect in the inspection.

5. The inspection device according to claim 1, wherein
the controller
specifies, in the inspection, a classification of a position where an image defect has occurred in each image, and
displays, in accordance with a classification of a position specified for each image, an image judged to be an image defect in the inspection.

6. The inspection device according to claim 1, wherein
the controller
displays, on a display device, a view indicating statistical information of an image defect in the inspection for the two or more jobs.

7. The inspection device according to claim 1, wherein
the controller
displays, in a same size, an image judged to be an image defect in the inspection for the two or more jobs.

8. The inspection device according to claim 1, wherein
the controller
displays, in a size output in each of the two or more jobs, an image judged to be an image defect in the inspection for the two or more jobs.

9. A non-transitory recording medium storing a computer readable program, by being executed by a processor of a computer, causing the computer to perform:
executing an inspection of an image of a sheet of paper by comparing the image of the sheet of paper output by a printing device for each of two or more jobs with a correct image of each image,
storing, in a memory of the computer, an image judged to be an image defect in the inspection, and
displaying, on a display device, a list of images judged to be an image defect in the inspection of the two or more jobs.

10. An inspection system comprising:
two or more printing devices; and
an information processing device, wherein
the information processing device includes
an interface that acquires information for deriving an inspection result by comparing images of two or more jobs output from the two or more printing devices with a correct image, and
a controller that displays the inspection result on a display device using information acquired via the interface.
